(19) United States
(12) Patent Application Publication
(10) Pub. No.: US 2023/0290318 A1
(43) Pub. Date: Sep. 14, 2023

(54) POWER-OPTIMIZED MONITOR

(71) Applicant: MediCapture, Inc., Plymouth Meeting, PA (US)

(72) Inventors: Alexander YURUSOV, New Taipei City (TW); Bernd JOTZAT, Heidelberg (DE)

(21) Appl. No.: 18/120,300

(22) Filed: Mar. 10, 2023

Related U.S. Application Data
(60) Provisional application No. 63/319,062, filed on Mar. 11, 2022.

(51) Int. Cl. G09G 5/00; G06F 13/42

(52) U.S. Cl. CPC G09G 5/003; G06F 13/4282; G09G 2330/021; G09G 2370/22; G09G 2330/026; G06F 2213/0042

(57) ABSTRACT

A power-optimized monitor includes a universal serial bus (USB) port for receiving power from a host computing device. The monitor is configured to be powered on 2.5 Watts for USB 2.0 standard and 4.5 Watts for USB 3.0 standard. Further, a method includes receiving power from the host computing device with a universal serial bus (USB) port of the monitor; displaying, with a display screen of the monitor, video images contained in the digital video signal received from the host computing device; decoding, with an input converter of the monitor, the digital video signal at the single input port from a first interface standard to a second interface standard; encoding, with an output converter of the monitor, the digital video signal in the second interface standard to a third interface standard, which matches an interface standard of the display screen. A further method includes receiving power and a digital video signal from a host computing device with a universal serial bus (USB) port; displaying, with a display screen of the monitor, video images contained in the digital video signal received from the host computing device; and configuring the monitor to support only a single set of video parameters, which exactly matches video parameters of the display screen.

### RELATED APPLICATIONS

This application claims the benefit of U.S. Provisional Application No. 63/319,062, filed Mar. 11, 2022, the entire disclosure of which is incorporated herein by reference.

### FIELD

The present disclosure relates to a monitor for a computing device. More particularly, the present disclosure relates to a power-optimized monitor that has been configured to be powered by a standard universal serial bus port of a computing device.

### BACKGROUND

Existing general-purpose monitors are designed for maximum flexibility and compatibility, thereby providing a variety of inputs of different types and supporting a wide range of input video resolutions. This flexibility substantially increases power requirements. For example, only scaling chip for the Full High-Definition resolution consumes 5 to 10 Watts of power, making it impossible to power a monitor solely from a standard downstream USB port, which can provide 2.5 Watts for USB 2.0 standard and 4.5 Watts of power for USB 3.0 standard.

### SUMMARY

Disclosed herein is a power-optimized monitor. In some embodiments, the monitor comprises: a single input port for receiving a digital video signal from a host computing device; a universal serial bus (USB) port for receiving power from the host computing device; and a display screen for displaying video images contained in the digital video signal received from the host computing device. The monitor is configured to operate on 2.5 watts of power or 4.5 watts of power.

In some embodiments, the power-optimized monitor further comprises an input converter configured for decoding the digital video signal at the single input port from a first interface standard to a second interface standard.

In some embodiments, the single input port is configured as a High-Definition Multimedia Interface (HDMI) interface and wherein the first interface standard comprises an HDMI interface standard.

In some embodiments, the single input port is configured as a DisplayPort (DP) interface and wherein the first interface standard comprises a DP interface standard.

In some embodiments, the power-optimized monitor further comprises an output converter configured for encoding the digital video signal in the second interface standard to a third interface standard, which matches an interface standard of the display screen.

In some embodiments, the power-optimized monitor further comprises a signal presence detector and a power switch or a power controller electrically connected to the USB port. The signal presence detector is configured for detecting whether the digital video signal at the single input port is stable and enabling the power switch or power controller to power on the display screen if the digital video signal is stable.

In some embodiments, the single input port is configured as a High-Definition Multimedia Interface (HDMI) interface. The input converter, the output converter and the signal presence detector comprise a HDMI-to-MIPI (Mobile Industry Processor Interface) converter.

In some embodiments, the power-optimized monitor further comprises a touch screen controller configured for implementing touch commands on the display screen.

The power-optimized monitor, in further embodiments, comprises: a universal serial bus (USB) port for receiving power and a digital video signal from a host computing device; and a display screen for displaying video images contained in the digital video signal received from the host computing device. This monitor is configured to support only a single set of video parameters, which exactly matches video parameters of the display screen. In some embodiments, this monitor further comprises a signal presence detector and a power controller electrically connected to the USB port. The signal presence detector is configured for detecting whether the digital video signal at the input port is stable and enabling the power controller to power on the display screen if the digital signal is stable. In some embodiments, this monitor further comprises a touch screen controller configured for implementing touch commands on the display screen. This monitor is also configured to operate on 2.5 watts of power or 4.5 watts of power.

Further disclosed herein is a method comprising: receiving a digital video signal from a host computing device with a single input port of a monitor; receiving power from the host computing device with a universal serial bus (USB) port of the monitor; displaying, with a display screen of the monitor, video images contained in the digital video signal received from the host computing device; decoding, with an input converter of the monitor, the digital video signal at the single input port from a first interface standard to a second interface standard; and encoding, with an output converter of the monitor, the digital video signal in the second interface standard to a third interface standard, which matches an interface standard of the display screen.

In some embodiments of the method, the single input port is configured as a High-Definition Multimedia Interface (HDMI) interface and wherein the first interface standard comprises an HDMI interface standard.

In some embodiments of the method, the single input port is configured as a DisplayPort (DP) interface and wherein the first interface standard comprises a DP interface standard.

In some embodiments, the method further comprises: detecting, with a signal presence detector of the monitor, whether the digital video signal at the single input port is stable; and enabling a power switch of the monitor or a power controller of the monitor, to power on the display screen if the detected video signal is stable.

In some embodiments, the method further comprises configuring the single input port as a High-Definition Multimedia Interface (HDMI) interface and configuring the input converter, the output converter and the signal presence detector as a HDMI-to-MIPI (Mobile Industry Processor Interface) converter.

In some embodiments, the method further comprises providing feedback to the host computing device, with a touch screen controller, when a user touches the display screen of the monitor.

The method, in further embodiments, comprises: receiving power and a digital video signal from a host computing device with a universal serial bus (USB) port; displaying, with a display screen of the monitor, video images contained in the digital video signal received from the host computing device; and configuring the monitor to support only a single set of video parameters, which exactly matches video parameters of the display screen. In some embodiments, this method further comprises: detecting, with a signal presence detector of the monitor, whether the digital video signal at the input port is stable; and enabling a power controller of the monitor, to power on the display screen if the detected video signal is stable. In some embodiments, this method further comprises providing feedback to the host computing device, with a touch screen controller, when a user touches the display screen of the monitor.

### BRIEF DESCRIPTION OF THE DRAWING

The disclosure is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and the drawing.

FIG. 1 illustrates an exemplary embodiment of a power-optimized monitor electrically connected with a host computing device which is configured to generate a digital video signal that contains video image data.

FIG. 2 is a block diagram of the electronic components of the power-optimized monitor according to an exemplary embodiment.

FIG. 3 is a block diagram of the power-optimized monitor according to another exemplary embodiment.

FIG. 4 is a block diagram of the power-optimized monitor according to a further exemplary embodiment.

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same. Further, “connected” and “coupled” are not restricted to physical or mechanical connections or couplings.

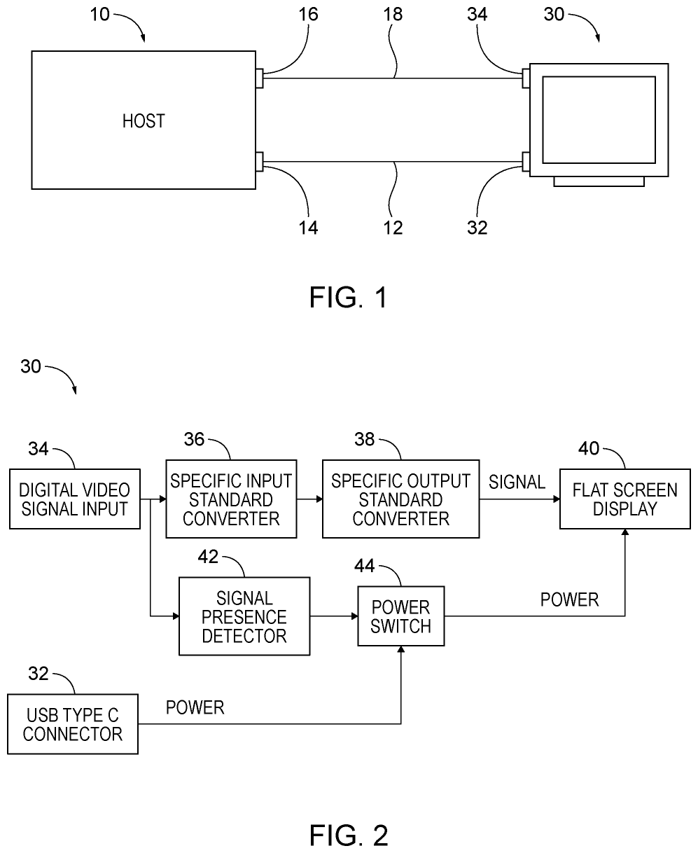

FIG. 1 illustrates an exemplary embodiment of a power-optimized monitor 30 electrically connected with a host computing device 10 which is configured to generate a digital video signal that contains video image data. The monitor 30 includes a display screen 40 for displaying video images produced by the monitor 30 from video image data transmitted from the host computing device 10 in the digital video signal. The monitor 30 is configured to be powered by a standard universal serial bus (USB) port 14 (i.e., USB 2.0 standard and/or USB 3.0 standard) of the host computing device 10. Since a standard USB port only provides 2.5 watts of power for the USB 2.0 standard and 4.5 watts of power for the USB 3.0 standard, the monitor 30 is configured to operate with only a particular type of host computing device 10, to reduce the power consumption of the monitor 30, so that it can be powered solely from the standard USB port 14 of that host computing device 10. In particular, the monitor 30, in some embodiments, is configured to support only a single set of video parameters (i.e., video resolution and video frame rate), which exactly matches the video parameters of the display screen 40 of the monitor 30. In addition, the monitor 10, in some embodiments, is configured with only a single digital video signal input port for connecting with the host computing device 10.

FIG. 2 is a block diagram of the electronic components of the power-optimized monitor 30 according to an exemplary embodiment. The monitor 30 includes a single external digital video signal input interface (single input port) 34 and a USB Type C external connection interface (USB port) 32. The monitor 30 further includes a specific input standard converter 36, a specific output standard converter 38, a display screen 40, a signal presence detector 42, and a power switch 44, all of which are well known components in the video display art.

The display screen 40 can comprise, without limitation, an LED, LCD, or OLED flat screen display. The display screen 40 can be configured according to a Mobile Industry Processor Interface (MIPI) standard, a Low Voltage Differential Signaling (LVDS) standard or some other standard.

The single input port 34 enables the monitor 30 to be connected with the host computing device 10 through a video cable 18 (FIG. 1) that transmits a digital video signal of a predetermined video format from a digital video output interface or port 16 of the host computing device 10. In one exemplary embodiment where the digital video output port 16 of the host computing device 10 is configured as a DisplayPort (DP) interface, the video cable 18 comprises a DP video cable and the single input port 34 comprises a DP input port. In another exemplary embodiment where the digital video output port 16 of the host computing device 10 is configured as a High-Definition Multimedia Interface (HDMI) interface, the video cable 18 comprises a HDMI video cable and the single input port 34 comprises a HDMI port.

The specific input standard converter 36 is provided for decoding the digital video signal at the single input port 34 from a first interface standard to a second or an intermediate interface standard, and the specific output standard converter 38 is provided for encoding the digital video signal from the intermediate interface standard to a third interface standard. More particularly, the video signal at the single input port 34 can be provided in a HDMI interface standard or a DP interface standard while the display screen 40 can be configured according to the MIPI interface standard, the LVDS interface standard or some other interface standard. Therefore, the specific input standard converter 36 is configured to decode the video signal in the HDMI interface standard (first interface standard), if the input port 34 is a HDMI interface, or a DP interface standard (first interface standard), if the input port 34 is a DP interface, to the intermediate interface standard, such as but not limited to a Digital RGB standard. After the video signal is decoded into the intermediate interface standard, the specific output standard converter 38 is configured to encode the signal at an output of the specific input standard converter 36, which signal is in the intermediate interface standard, into the interface standard (third interface standard) of the display screen 40 (e.g., MIPI, LVDS, etc), and provide the encoded signal at an output of the specific output standard converter 38 so the display screen 40 can display the video.

The USB port 32 enables the monitor 30 to be electrically powered by the USB port 14 of the host computing device 10, via a USB cable 12 that is electrically connected at a first end to the USB port 14 of the host computing device 10 and at a second end to the USB port 32 of the monitor 30, as illustrated in FIG. 1. The USB port 32 transmits power at the USB port 14 of the host device 10, to the power switch 44, which in turn is configured to transmit that power to the display screen 40 (as well as the input standard converter 36, the specific output standard converter 38, and the signal presence detector 42) when the host computing device 10 provides power and a digital video signal to the monitor 40.

The signal presence detector 42 provides additional power conservation by detecting whether a stable video signal is present at the single input port 34 and if so, enables the power switch 44 to turn on the power for the display screen 40. Typically, a HDMI interface or a DP interface includes a Hot Plug Detection pin. A high signal level on this pin indicates that a video signal is provided by the host computing device. Before the signal presence detector 42 enables the power switch 44, the signal presence detector 42 is configured to decode the video signal at the single input port 34, to detect the resolution of the video signal. When the detected stable video signal is decoded successfully and the detected resolution is confirmed to be the same for at least 3 consecutive video frames, the signal presence detector 42 will then enable the power switch 44 to turn on power for the display screen 40 to power display signal circuits and a backlight of the display screen 40.

The specific input standard converter 36, the specific output standard converter 38 and the signal presence detector 42 can be implemented in one or more integrated circuits (ICs).

A power-optimized monitor made according to an exemplary embodiment of the present disclosure, comprises a single input port in the HDMI interface standard, a USB port, and a display screen having a diagonal size of 10.1 inches, a high-definition resolution of 1920 by 1200 pixels, a frame rate of 60 Hertz, and touch screen and display functions. This power-optimized monitor consumes only 2 watts of power from a standard USB 2.0 port of a host computing device.

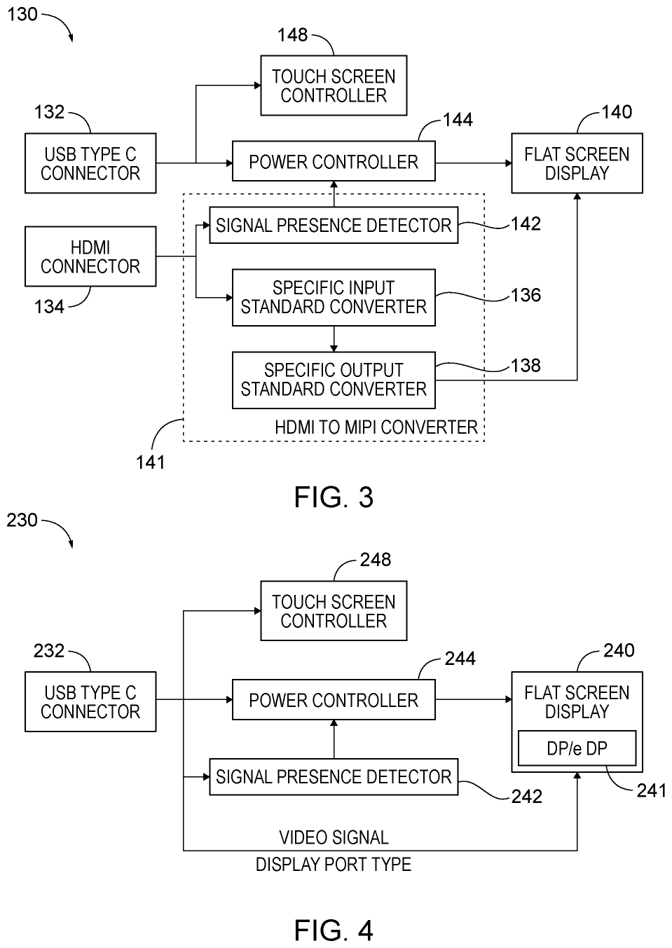

FIG. 3 is a block diagram of the power-optimized monitor 130 according to another exemplary embodiment. The monitor 130 includes a USB port 132, a power controller 136, a touch screen controller 148, a single input port comprising a HDMI connector or port 134, a HDMI-to-MIPI converter 141, and a display screen 140.

As in the previous embodiment of FIG. 2, the USB port 132 (a USB Type C external connection interface) enables the monitor 130 to be electrically powered by the standard USB port 14 of the host computing device 10, via the USB cable 12 illustrated in FIG. 1. The USB port 132 transmits power to the power controller 144, which in turn transmits power to the display screen 140 when the host computing device 10 provides power and the digital video signal to the monitor 130 using a touch command, i.e., touching the display screen 140. The power controller 144 can include one or more DC/DC converters, which convert input direct current at the USB port 132 to power display signal circuits and backlight of the display screen 140.

The HDMI port 134, enables the monitor 130 to be connected with the port 16 of the host computing device 10 through the video cable 18 that transmits a digital video signal in the HDMI format, as illustrated in FIG. 1. The HDMI port 134 is electrically connected with the HDMI-to-MIPI converter 141. The HDMI-to-MIPI converter 14 integrates a signal presence detector 142, a specific input standard converter 136, and a specific output standard converter 138, into a single IC. The signal presence detector 142, specific input standard converter 136, and specific output standard converter 138 operate in essentially same manner as described earlier with respect to the signal presence detector 42, the specific input standard converter 36, and the specific output standard converter 38 of the monitor of FIG. 2. In particular, the signal presence detector 142 enables the power controller 144 to turn on the power for the display screen 140 only if a stable video signal is present at the HDMI port 134 and decodes the video signal to detect the resolution thereof. The specific input standard converter 136 decodes the video signal in the HDMI interface standard at the HDMI port 134 to an intermediate interface standard and the specific output standard converter 138 encodes the signal in the intermediate interface standard at an output of the specific input standard converter 136 into the interface standard of the display screen 140, so the display screen 140 can display the video.

The touch screen controller 148 provides feedback to the host computing device 10 (FIG. 1), via the USB port 132, when a user touches the display screen 140, which is configured to implement touch commands (e.g., tap, swipe, pinch, and the like). The touch screen controller 148 can be implemented as an IC.

FIG. 4 is a block diagram of the power-optimized monitor 230 according to a further exemplary embodiment. In this embodiment, the specific input standard converters 36 and 136 and the specific output standard converters 38 and 138 described with respect to the monitors 30 and 130 embodied in respective FIGS. 2 and 3, are omitted in the monitor 230 of the present embodiment. This is made possible by configuring a display screen 240 of the monitor 230 with a DP or eDP (embedded DisplayPort) interface 241 and providing the monitor with a single external connection interface comprising a USB port 232 (a USB Type C external connection interface) that receives power and an input video signal in a DP format transmitted by the host computing device via a USB type C cable. The video signal at the USB port 232 is transmitted to the display screen 240 via a power controller 244 of the monitor 230. Therefore, the monitor 230 does not require the single input ports 34 and 134 provided in the monitors 30 and 130 embodied in FIGS. 2 and 3, as the USB port 232 is operative as an external digital video signal input interface and a power source. Further, the monitor 230 does not require any user controls, such as buttons, as the display screen 240 is configured to implement touch commands and the touch screen controller 248 provides feedback to the host computing device, via the USB port 232, when a user touches the display screen 240. The signal presence detector 242 enables the power controller 244 to turn on the power for the display screen 240 only if a stable video signal is present at the USB port 232 and decodes the video signal to detect the resolution thereof.

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. A power-optimized monitor comprising:
a single input port for receiving a digital video signal from a host computing device;
a universal serial bus (USB) port for receiving power from the host computing device; and
a display screen for displaying video images contained in the digital video signal received from the host computing device;
wherein the monitor is configured to operate on 2.5 watts of power or 4.5 watts of power.

2. The power-optimized monitor of claim 1, further comprising an input converter configured for decoding the digital video signal at the single input port from a first interface standard to a second interface standard.

3. The power-optimized monitor of claim 2, wherein the single input port is configured as a High-Definition Multimedia Interface (HDMI) interface and wherein the first interface standard comprises an HDMI interface standard.

4. The power-optimized monitor of claim 2, wherein the single input port is configured as a DisplayPort (DP) interface and wherein the first interface standard comprises a DP interface standard.

5. The power-optimized monitor of claim 2, further comprising an output converter configured for encoding the digital video signal in the second interface standard to a third interface standard, which matches an interface standard of the display screen.

6. The power-optimized monitor of claim 5, further comprising:
a signal presence detector; and
a power switch or a power controller electrically connected to the USB port;
wherein the signal presence detector is configured for:
detecting whether the digital video signal at the single input port is stable; and
enabling the power switch or power controller to power on the display screen if the digital video signal is stable.

7. The power-optimized monitor of claim 6, wherein the single input port is configured as a High-Definition Multimedia Interface (HDMI) interface and wherein the input converter, the output converter and the signal presence detector comprise a HDMI-to-MIPI (Mobile Industry Processor Interface) converter.

8. The power-optimized monitor of claim 1, further comprising a touch screen controller configured for implementing touch commands on the display screen.

9. A power-optimized monitor comprising:
a universal serial bus (USB) port for receiving power and a digital video signal from a host computing device; and
a display screen for displaying video images contained in the digital video signal received from the host computing device;
wherein the monitor is configured to support only a single set of video parameters, which exactly matches video parameters of the display screen.

10. The power-optimized monitor of claim 9, further comprising:
a signal presence detector; and
a power controller electrically connected to the USB port;
wherein the signal presence detector is configured for:
detecting whether the digital video signal at the input port is stable; and
enabling the power controller to power on the display screen if the digital signal is stable.

11. The power-optimized monitor of claim 9, further comprising a touch screen controller configured for implementing touch commands on the display screen.

12. A method comprising:
receiving a digital video signal from a host computing device with a single input port of a monitor;
receiving power from the host computing device with a universal serial bus (USB) port of the monitor;
displaying, with a display screen of the monitor, video images contained in the digital video signal received from the host computing device;
decoding, with an input converter of the monitor, the digital video signal at the single input port from a first interface standard to a second interface standard; and
encoding, with an output converter of the monitor, the digital video signal in the second interface standard to a third interface standard, which matches an interface standard of the display screen.

13. The method of claim 12, wherein the monitor operates on 2.5 watts of power or 4.5 watts of power.

14. The method of claim 12, wherein the single input port is configured as a High-Definition Multimedia Interface (HDMI) interface and wherein the first interface standard comprises an HDMI interface standard.

15. The method of claim 12, wherein the single input port is configured as a DisplayPort (DP) interface and wherein the first interface standard comprises a DP interface standard.

16. The method of claim 12, further comprising:
detecting, with a signal presence detector of the monitor, whether the digital video signal at the single input port is stable; and
enabling a power switch of the monitor or a power controller of the monitor, to power on the display screen if the detected video signal is stable.

17. The method of claim 16, further comprising:
configuring the single input port as a High-Definition Multimedia Interface (HDMI) interface; and
configuring the input converter, the output converter and the signal presence detector as a HDMI-to-MIPI (Mobile Industry Processor Interface) converter.

18. The method of claim 12, further comprising providing feedback to the host computing device, with a touch screen controller, when a user touches the display screen of the monitor.

19. A method comprising:
receiving power and a digital video signal from a host computing device with a universal serial bus (USB) port;
displaying, with a display screen of the monitor, video images contained in the digital video signal received from the host computing device; and
configuring the monitor to support only a single set of video parameters, which exactly matches video parameters of the display screen.

20. The method of claim 19, further comprising:
detecting, with a signal presence detector of the monitor, whether the digital video signal at the input port is stable; and
enabling a power controller of the monitor, to power on the display screen if the detected video signal is stable.

21. The method of claim 20, further comprising providing feedback to the host computing device, with a touch screen controller, when a user touches the display screen of the monitor.
